(19) United States
(12) Patent Application Publication
(10) Pub. No.: US 2018/0188841 A1
(43) Pub. Date: Jul. 5, 2018

(54) TOUCH SCREEN AND TOUCH SENSING ASSEMBLY THEREOF

(71) Applicant: Wuhan China Star Optoelectronics Technology Co., Ltd., Wuhan, Hubei (CN)

(72) Inventor: Yun YU, Shenzhen, Guangdong (CN)

(73) Assignee: Wuhan China Star Optoelectronics Technology Co., Ltd., Wuhan, Hubei (CN)

(21) Appl. No.: 15/308,342

(22) PCT Filed: Oct. 9, 2016
(86) PCT No.: PCT/CN2016/101524

§ 371 Date: Nov. 1, 2016

(30) Foreign Application Priority Data
Aug. 24, 2016 (CN) 201610717711.X

(51) Int. Cl. G06F 3/044

(52) U.S. Cl. CPC G06F 3/044; G06F 2203/04111

(57) ABSTRACT

A touch screen and a touch sensing assembly thereof are provided, the touch sensing assembly includes a substrate and an electrode array disposed thereon, the electrode array includes a plurality of first electrodes arranged along a first direction and a plurality of second electrodes arranged along a second direction. Two first conductive bridges connect two adjacent first electrodes along the first direction, two second conductive bridges connect two adjacent second electrodes along the second direction. The touch sensing assembly further includes an insulating layer disposed between the first conductive bridges and the second conductive bridges. According to the touch sensing assembly provided by the disclosure, two adjacent first electrodes can still be conducted when one of the first conductive bridges is broken, identically, two adjacent second electrodes can also be conducted when one of the second conductive bridges is broken, improve sensing effects of the touch sensing assembly.

### BACKGROUND OF THE INVENTION

### 1. Field of the Invention

The disclosure relates to a touch screen manufacture technical field, and more particularly to a touch screen and a touch sensing assembly thereof.

### 2. Discussion of the Related Art

In recent years, a touch screen gradually substitutes a keyboard or a pointing device to be an input device of a portable terminal. An ITO transparent conductive thin film is plated on a surface of a substrate and patterned to form an ITO electrode layer in design of a conventional touch screen, the ITO electrode layer includes driving electrodes and sensing electrodes disposed vertically as columns, then adjacent driving electrodes and adjacent sensing electrodes are connected by a metallic conductive bridge respectively, so that the ITO electrode layer is connected and conducted. But in design of the touch screen, if errors occur during deposition of the metallic conductive bridge, an open circuit can be easily caused and the ITO electrode layer cannot be conducted, which affect sensing effects of the touch screen.

### SUMMARY

In order to solve shortcomings of a conventional technique, the disclosure provides a touch screen and a touch sensing assembly thereof, which can improve sensing effects of the touch sensing assembly.

The disclosure provides a touch sensing assembly, including a substrate and an electrode array disposed on the substrate, the electrode array includes a plurality of first electrodes arranged along a first direction and a plurality of second electrodes arranged along a second direction. Two first conductive bridges connect two adjacent first electrodes along the first direction, two second conductive bridges connect two adjacent second electrodes along the second direction. The touch sensing assembly further includes an insulating layer disposed between the first conductive bridges and the second conductive bridges.

Wherein the two first conductive bridges are parallel and/or intersecting.

Wherein the two second conductive bridges are parallel and/or intersecting.

Wherein the first electrode includes a first part and a first conductive frame extending from the first part, the first conductive bridge is connected with the first conductive frame of the adjacent first electrode. The second electrode includes a second part and a second conductive frame extending from the second part, the second conductive bridge is connected with the second conductive frame of the adjacent second electrode.

Wherein the first conductive frames of the two adjacent first electrodes extend toward each other.

Wherein the first conductive frames of the two adjacent first electrodes are mutually parallel.

Wherein the second conductive frames of the two adjacent second electrodes extend toward each other.

Wherein the second conductive frames of the two adjacent second electrodes are mutually parallel.

Wherein the touch sensing assembly further includes a dummy section disposed among the first electrodes and the second electrodes, the dummy section is separated from the first electrodes and the second electrodes.

The disclosure further provides a touch screen, including the touch sensing assembly mentioned above.

The disclosure provides the touch screen and the touch sensing assembly thereof, two adjacent first electrodes are connected by two first conductive bridges, two adjacent second electrodes are connected by two second conductive bridges, so that the two adjacent first electrodes can still be conducted when one of the first conductive bridges is broken, identically, the two adjacent second electrodes can also be conducted when one of the second conductive bridges is broken, which can improve sensing effects of the touch sensing assembly.

### BRIEF DESCRIPTION OF THE DRAWINGS

FIG. 1 is a structural schematic view of a touch screen according to a first embodiment.

FIG. 2 is a structural schematic view of a touch sensing assembly according to the first embodiment.

FIG. 3 is a structural schematic view of a touch sensing assembly according to a second embodiment.

FIG. 4 is a structural schematic view of a touch sensing assembly according to a third embodiment.

FIG. 5 is a structural schematic view of a touch sensing assembly according to a fourth embodiment.

### DETAILED DESCRIPTION OF PREFERRED EMBODIMENTS

Embodiments of the disclosure will be described in detail with reference to the accompanying drawings as follows. However, the disclosure can be achieved in various forms, and the disclosure should not be explained to be limited by the described embodiments. In the contrary, the embodiments are provided for illustrating the principle and practical application of the disclosure, so that a person skilled in the art can understand all kinds of embodiments of the disclosure and modifications adapted to certain anticipation. In the figures, a same label will be utilized to represent an identical element.

A touch sensing assembly provided by the disclosure includes a substrate and an electrode array disposed on the substrate, the electrode array includes a plurality of first electrodes arranged along a first direction and a plurality of second electrodes arranged along a second direction, the first electrodes and the second electrodes are separated mutually, the first electrodes and the second electrodes are on a same side of the substrate. Two first conductive bridges connect two adjacent first electrodes along the first direction, two second conductive bridges connect two adjacent second electrodes along the second direction. The touch sensing assembly further includes an insulating layer disposed between the first conductive bridges and the second conductive bridges.

### First Embodiment

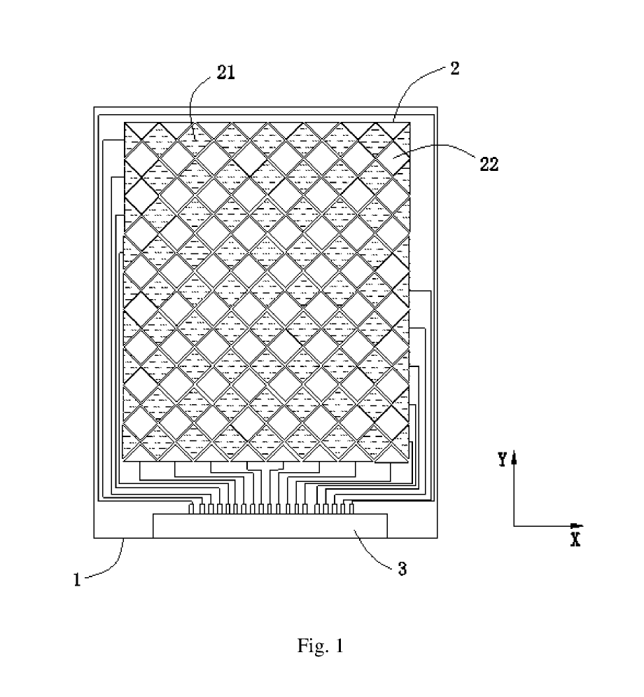

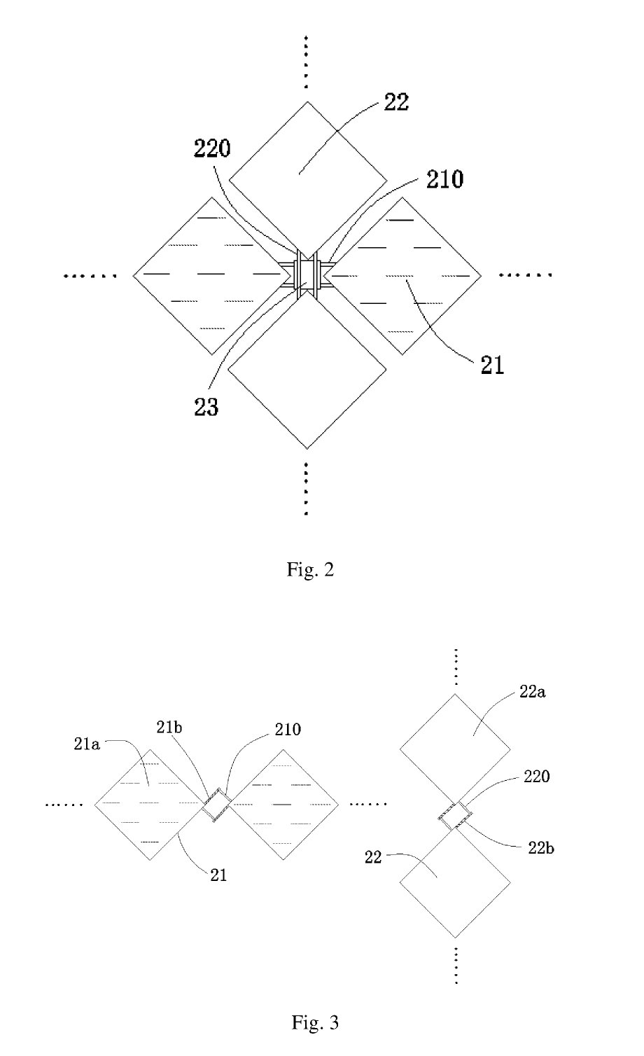

Referring to FIG. 1, FIG. 2, a touch sensing assembly provided by the embodiment includes a substrate 1 and an electrode array 2 disposed on the substrate 1. The substrate is a flexible substrate, material of which is flexible material such as PET, PI or enhanced polycarbonate. The electrode array 2 includes a plurality of first electrodes 21 arranged along a first direction and a plurality of second electrodes 22 arranged along a second direction, the first electrodes 21 and the second electrodes 22 are separated mutually, the first direction is an X direction in FIG. 1, the second direction is a Y direction in FIG. 1. The two adjacent first electrodes 21 along the X direction are connected by two first conductive bridges 210, the two adjacent second electrodes 22 along the Y direction are connected by two second conductive bridges 220, the touch sensing assembly further includes an insulating layer 23 disposed between the first conductive bridges 210 and the second conductive bridges 220.

Specifically, the electrode array 2 is an ITO thin film, the first conductive bridges 210 and the second conductive bridges 220 are metallic wires, for instance, copper, molybdenum, aluminum or an alloy of them. A shape of the first electrodes 21 and the second electrodes 22 is rectangular or rhombic, diagonals of the two adjacent first electrodes 21 along the X direction are on a same line and a direction of the diagonals of the two adjacent first electrodes 21 and the X direction are parallel, the two first conductive bridges 210 are disposed between the two adjacent first electrodes 21 parallel and contacted with two opposite corners of the two adjacent first electrodes 21. Identically, diagonals of the two adjacent second electrodes 22 along the Y direction are on a same line and a direction of the diagonals of the two adjacent second electrodes 22 and the Y direction are parallel, the two second conductive bridges 220 are disposed between the two adjacent second electrodes 22 parallel and contacted with two opposite corners of the two adjacent second electrodes 22. The insulating layer 23 is disposed between the two first conductive bridges 210 and the two second conductive bridges 220, a thickness of the insulating layer 23 is 50 nm, material of which is SiNₓ. The embodiment merely enumerates a situation that the two adjacent first electrodes 21 are connected by the two first conductive bridges 210 and the two adjacent second electrodes 22 are connected by the two second conductive bridges 220, obviously, the two adjacent first electrodes 21 can be connected by more than two first conductive bridges 210 or the two adjacent second electrodes 22 can be connected by more than two second conductive bridges 220 according to realty.

In the embodiment, the two adjacent first electrodes 21 along the X direction are connected by the two first conductive bridges 210, when one of the first conductive bridges 210 is broken, the two adjacent first electrodes 21 can be connected by the other first conductive bridge 210, parallel, the two adjacent second electrodes 22 along the Y direction are connected by the two second conductive bridges 220, when one of the second conductive bridges 220 is broken, the two adjacent second electrodes 22 can be connected by the other second conductive bridge 220, so as to improve sensing effects of the touch sensing assembly.

The embodiment further provides a touch screen, including the touch sensing assembly mentioned above and FPC 3, the first electrodes 21 arranged along the X direction and the second electrodes 22 arranged along the Y direction in the electrode array 2 are connected with FPC 3 respectively by wires disposed on the substrate 1.

### Second Embodiment

Referring to FIG. 3, the touch sensing assembly in the embodiment is an improvement of that in the first embodiment, a difference of the touch sensing assembly in the embodiment and the touch sensing assembly in the first embodiment is that the first electrode 21 includes a first part 21a and a first conductive frame 21b extending from the first part 21a, the second electrode 22 includes a second part 22a and a second conductive frame 22b extending from the second part 22a.

Specifically, the first conductive frames 21b are achieved by extending two opposite parallel sides of the two adjacent first electrodes 21 respectively, and the first conductive frames 21b are between the two adjacent first electrodes 21. The two first conductive bridges 210 are disposed between the two first conductive frames 21b parallel and connected with first conductive frames 21b, the two first conductive bridges 210 and the two first conductive frames 21b form a rectangle or a rhombus. One of the two first conductive frames 21b and one of the two first conductive bridges 210 form a first channel between the two adjacent first electrodes 21, the other one of the two first conductive frames 21b and the other one of the two first conductive bridges 210 form a second channel between the two adjacent first electrodes 21. Equally, the second conductive frames 22b are achieved by extending two opposite parallel sides of the two adjacent second electrodes 22 respectively, and the second conductive frames 22b are between the two adjacent second electrodes 22. The two second conductive bridges 220 are disposed between the two second conductive frames 22b parallel and connected with the second conductive frames 22b, the two second conductive bridges 220 and the two second conductive frames 22b form a rectangle or a rhombus. One of the two second conductive frames 22b and one of the two second conductive bridges 220 form a first channel between the two adjacent second electrodes 22, the other one of the two second conductive frames 22b and the other one of the two second conductive bridges 220 form a second channel between the two adjacent second electrodes 22. The insulating layer 23 (not shown in FIG. 3) is disposed between the two first conductive bridges 210 and the two conductive bridges 220 as well as between the two first conductive frames 21b and the two conductive frames 22b.

The embodiment merely enumerates a situation that the two first conductive frames 21b are disposed between the two adjacent first electrodes 21 and the two conductive frames 22b are disposed between the two adjacent second electrodes 22, obviously, more first conductive bridges 210 can be disposed between the two adjacent first electrodes 21 or more second conductive bridges 220 can be disposed between the two adjacent second electrodes 22 according to realty.

According to the embodiment, the two first conductive frames 21b are disposed between the two first electrodes 21 and the two second conductive frames 22b are disposed between the two second electrodes 22, so that a certain distance exists between points of junction of the two first conductive bridges 210 and the first electrodes 21 respectively as well as a certain distance exists between points of junction of the two second conductive bridges 220 and the second electrodes 22, which can prevent two points of junction from being too closed so as to cause the two conductive bridges and electrodes to break simultaneously, in order to further improve sensing effects of the touch sensing assembly.

### Third Embodiment

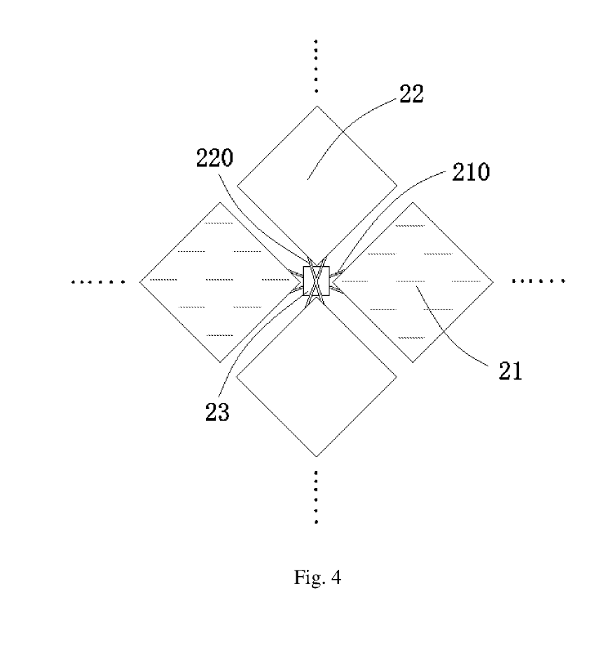

Referring to FIG. 4, the touch sensing assembly in the embodiment is an improvement of those in the first embodiment and in the second embodiment, a difference of the touch sensing assembly in the embodiment and the touch sensing assembly in the first embodiment is that the two first conductive bridges 210 are disposed between the two adjacent first electrodes 21 across and contacted with two opposite corners of the two adjacent first electrodes 21, the two second conductive bridges 220 are disposed between the two adjacent second electrodes 22 across and contacted with two opposite corners of the two adjacent second electrodes 22. The two first conductive bridges 210 and the two second conductive bridges 220 are shown as “X” patterns, the two first conductive bridges 210 and the two second conductive bridges 220 are communicated at the points of junction, accordingly, four communication channels are formed between the two adjacent first electrodes 21 by the two first conductive bridges 210 and four communication channels are formed between the two adjacent second electrodes 22 by the two second conductive bridges 220.

The two first conductive bridges 210 and the two conductive bridges 220 in the embodiment are communicated at the points of junction, four communication channels are formed between the two adjacent first electrodes 21 and the two adjacent second electrodes 22 respectively, so as to reduce possibility of fracture between two adjacent electrodes, further improving sensing effects of the touch sensing assembly.

### Fourth Embodiment

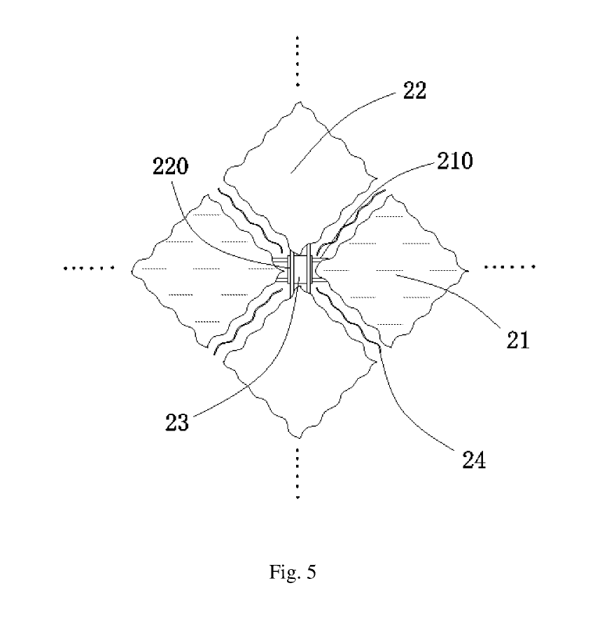

Referring to FIG. 5, a difference of the embodiment and the first embodiment is that the touch sensing assembly further includes a dummy section 24 disposed among the first electrodes 21 and the second electrodes 22, the dummy section 24 is separated from the first electrodes 21 and the second electrodes 22. The dummy section 24 is disposed in a blank of the electrode array, which is not communicated with the first electrodes 21 or the second electrodes 22.

The dummy section 24 added in the embodiment can blur boundaries of the adjacent first electrodes 21 as well as the first electrodes 21 and the second electrodes 22, so as to improve visual effects of the touch sensing assembly.

Above are merely embodiments of the disclosure, improvement and modification obtained by a person skilled in the art according to the principle of the application should be covered by the protected scope of the disclosure.

What is claimed is:

1. A touch sensing assembly, comprising a substrate and an electrode array disposed on the substrate, the electrode array comprising a plurality of first electrodes arranged along a first direction and a plurality of second electrodes arranged along a second direction; two first conductive bridges connecting two adjacent first electrodes along the first direction, two second conductive bridges connecting two adjacent second electrodes along the second direction, the touch sensing assembly further comprising an insulating layer disposed between the first conductive bridges and the second conductive bridges.

2. The touch sensing assembly according to claim 1, wherein the two first conductive bridges are parallel and/or intersecting.

3. The touch sensing assembly according to claim 1, wherein the two second conductive bridges are parallel and/or intersecting.

4. The touch sensing assembly according to claim 1, wherein the first electrode comprises a first part and a first conductive frame extending from the first part, the first conductive bridge is connected with the first conductive frame of the adjacent first electrode, the second electrode comprises a second part and a second conductive frame extending from the second part, the second conductive bridge is connected with the second conductive frame of the adjacent second electrode.

5. The touch sensing assembly according to claim 4, wherein the first conductive frames of the two adjacent first electrodes extend toward each other.

6. The touch sensing assembly according to claim 5, wherein the first conductive frames of the two adjacent first electrodes are mutually parallel.

7. The touch sensing assembly according to claim 4, wherein the second conductive frames of the two adjacent second electrodes extend toward each other.

8. The touch sensing assembly according to claim 7, wherein the second conductive frames of the two adjacent second electrodes are mutually parallel.

9. The touch sensing assembly according to claim 1, wherein the touch sensing assembly further comprises a dummy section disposed among the first electrodes and the second electrodes, the dummy section is separated from the first electrodes and the second electrodes.

10. A touch screen, comprising the touch sensing assembly according to claim 1.

11. The touch screen according to claim 10, wherein the first conductive bridges are parallel and/or intersecting.

12. The touch screen according to claim 10, wherein the two second conductive bridges are parallel and/or intersecting.

13. The touch screen according to claim 10, wherein the first electrode comprises a first part and a first conductive frame extending from the first part, the first conductive bridge is connected with the first conductive frame of the adjacent first electrode, the second electrode comprises a second part and a second conductive frame extending from the second part, the second conductive bridge is connected with the second conductive frame of the adjacent second electrode.

14. The touch screen according to claim 13, wherein the first conductive frames of the two adjacent first electrodes extend toward each other.

15. The touch screen according to claim 14, wherein the first conductive frames of the two adjacent first electrodes are mutually parallel.

16. The touch screen according to claim 13, wherein the second conductive frames of the two adjacent second electrodes extend toward each other.

17. The touch screen according to claim 16, wherein the second conductive frames of the two adjacent second electrodes are mutually parallel.

18. The touch screen according to claim 10, wherein the touch sensing assembly further comprises a dummy section disposed among the first electrodes and the second electrodes, the dummy section is separated from the first electrodes and the second electrodes.
